(19) United States
(12) Patent Application Publication
(10) Pub. No.: US 2020/0314261 A1
(43) Pub. Date: Oct. 1, 2020

(54) COMMUNICATION SYSTEM, IMAGE FORMATION DEVICE, AND COMMUNICATION METHOD

(71) Applicant: Oki Data Corporation, Tokyo (JP)

(72) Inventor: Takahiro TSUNO, Tokyo (JP)

(73) Assignee: Oki Data Corporation, Tokyo (JP)

(21) Appl. No.: 16/788,223

(22) Filed: Feb. 11, 2020

(30) Foreign Application Priority Data
Mar. 27, 2019 (JP) 2019-061723

(51) Int. Cl. H04N 1/00; H04W 4/80

(52) U.S. Cl. CPC H04N 1/00307; H04N 2201/0075; H04N 2201/006; H04W 4/80

(57) ABSTRACT

An image formation device according to one or more embodiments may be include: an IC tag communicable with a tag reader of the mobile terminal through an NFC connection therebetween; a storage storing therein a setting value information including an NFC setting of the image formation device; and a controller. The controller is configured with programs to perform operations comprising: when receiving, from the mobile terminal via the network, a transmission request of the setting value information of the image formation device, reading the setting value information from the storage of the image formation device and transmitting the setting value information to the mobile terminal; and when receiving via the network from the mobile terminal an activation instruction to activate an NFC function of the image formation device, activating the NFC function of the image formation device.

### CROSS REFERENCE TO RELATED APPLICATIONS

This application claims priority based on 35 USC 119 from prior Japanese Patent Application No. 2019-061723 filed on Mar. 27, 2019 entitled “COMMUNICATION SYSTEM, IMAGE FORMATION DEVICE, AND COMMUNICATION METHOD”, the entire contents of which are incorporated herein by reference.

### BACKGROUND

The disclosure may relate to a communication system, an image formation device such as a multifunction printer, and a communication method for performing printing, scanning, and the like using a mobile terminal such as a smartphone.

In a communication system using a mobile terminal in a related art, if an NFC function of the mobile terminal is OFF when a print application program (hereinafter referred to as “print AP”) is started, the print AP automatically turns on the NFC function of the mobile terminal, acquires connection information from an IC tag of the image formation device, and executes a handover process based on the acquired connection information (for example, see Patent Document 1).

Patent Document 1: Japanese Patent Application Publication No. 2017-34379 (paragraphs 0015, 0041-0049, and FIG. 6)

### SUMMARY

However, in the related art described above, when the user performs printing or scanning using the NFC function of the mobile terminal, if the NFC function is inactive based on the device setting of the image formation device, the user may need to manually re-activate the NFC function of the image formation device. This may decrease a user convenience.

An object of an aspect of one or more embodiments is to enable printing using an NFC function of a mobile terminal even when an NFC function of an image formation device is set to be inactive.

An aspect of one or more embodiments may be an a communication system that may include: a mobile terminal and an image formation device, wherein the mobile terminal and the image formation device are communicable via a network using a wireless connection and a tag reader of the mobile terminal and an IC tag of the image formation device are communicable by using an NFC function, in which the image formation device includes a storage storing therein a setting value information including an NFC setting and the IC tag storing therein a device identification information to identify the image formation device via the network. The mobile terminal may include a controller configured with programs to perform operations comprising: transmitting, via the network to the image formation device, a transmission request of the setting value information including the NFC setting of the image formation device; when the NFC setting in the setting value information received via the network indicates the NFC function of the image formation device is inactive, transmitting, via the network to the image formation device, an activation instruction to activate the NFC function; and after transmitting the activation instruction, reading, from the IC tag of the image formation device, the device identification information by means of the tag reader using the NFC function. The image formation device may include a controller configured with programs to perform operations comprising: when receiving, from the mobile terminal via the network, the transmission request of the setting value information of the image formation device, reading the setting value information from the storage of the image formation device and transmitting the setting value information to the mobile terminal; and when receiving the activation instruction via the network from the mobile terminal, activating the NFC function of the image formation device.

An aspect of one or more embodiments may be a communication system that may include: a mobile terminal and image formation devices, wherein the mobile terminal and each of the image formation devices are communicable via a network using a wireless connection and a tag reader/writer of the mobile terminal and an IC tag of each of the image formation devices are communicable by using an NFC function, in which each of the image formation devices includes a storage storing therein a setting value information including an NFC setting and the IC tag storing therein a device identification information to identify the image formation device via the network. The mobile terminal may include a controller configured with programs to perform operations comprising: transmitting, via the network to each of the image formation devices, the transmission request of the setting value information including the NFC setting of the image formation device; when the NFC setting in the setting value information received via the network indicates there is one or more image formation devices whose NFC functions are inactive, transmitting, via the network to the one or more image formation devices, a restricted activation instruction to activate the NFC function with restriction; after transmitting the restricted activation instruction, transmitting the terminal identification information to identify the mobile terminal via the network to the image formation devices whose NFC functions have already been active with the restriction and the one or more image formation devices to which the restricted activation instruction has been transmitted; and after transmitting the terminal identification information, reading, from the IC tag of one of the image formation devices, the device identification information to identify the one of the image formation devices via the network by means of the tag reader/writer using the NFC function, and writing the terminal identification information of the mobile terminal to the IC tag of the one of the image formation devices. Each of the image formation devices may include a controller configured with programs to perform operations comprising: when receiving, from the mobile terminal via the network, the transmission request of the setting value information of the image formation device, reading the setting value information from the storage of the image formation device and transmitting the setting value information to the mobile terminal; when receiving the restricted activation instruction via the network from the mobile terminal, activating the NFC function of the image formation device with the restriction; when receiving the terminal identification information via the network from the mobile terminal, storing the received terminal identification information in the storage of the image formation device; and when the terminal identification information written in the IC tag matches the terminal identification information stored in the storage, allowing communication via the network.

An aspect of one or more embodiments may be an image formation device communicable with a mobile terminal via a network using a wireless connection. The image formation device may include: an IC tag communicable with a tag reader of the mobile terminal through an NFC connection between the IC tag and the tag reader, wherein the IC tag stores therein a device identification information to identify the image formation device via the network; a storage storing therein a setting value information including an NFC setting of the image formation device; and a controller. The controller may be configured with programs to perform operations comprising: when receiving, from the mobile terminal via the network, a transmission request of the setting value information of the image formation device, reading the setting value information from the storage of the image formation device and transmitting the setting value information to the mobile terminal; and when receiving via the network from the mobile terminal an activation instruction to activate an NFC function of the image formation device, activating the NFC function of the image formation device.

An aspect of one or more embodiments may be an image formation device communicable with a mobile terminal via a network using a wireless connection. The image formation device may include: an IC tag communicable with a tag reader/writer of the mobile terminal through an NFC connection between the IC tag and the tag reader/writer, wherein the IC tag stores therein a device identification information to identify the image formation device via the network; a storage storing therein a setting value information including an NFC setting of the image formation device; a controller. The controller may be configured with programs to perform operations comprising: when receiving, from the mobile terminal via the network, a transmission request of the setting value information of the image formation device, reading the setting value information from the storage of the image formation device and transmitting the setting value information to the mobile terminal; when receiving via the network from the mobile terminal a restricted activation instruction to activate an NFC function of the image formation device with restriction, activating the NFC function of the image formation device with the restriction; when receiving via the network from the mobile terminal a terminal identification information to identify the mobile terminal, storing the received terminal identification information into the storage of the image formation device; and allowing communication via the network, when terminal identification information written in the IC tag of the image formation device matches the received terminal identification information stored in the storage of the image formation device.

An aspect of one or more embodiments may be a communication method of communicating a mobile terminal with an image formation device via a network using a first wireless connection and via a near field communication (NFC) using a second wireless connection. The method may include: transmitting, via the network from the mobile terminal to the image formation device, an instruction to activate an NFC function of the image formation device from an inactive state; communicating via the NFC between the mobile terminal and the image formation device, to receive a device identification information of the image formation device by the mobile terminal; communicating, via the network between the mobile terminal and the image formation device that is identified by the device identification information; and transmitting, via the network from the mobile terminal to the image formation device, an instruction to deactivate the NFC function of the image formation device from the activated state.

According to at least one of the above aspects, the mobile terminal can read information for identifying the image formation device using the NFC function without the user being conscious of the NFC setting of the image formation device. This may improve a user convenience.

### BRIEF DESCRIPTION OF DRAWINGS

FIG. 1 is a block diagram illustrating a view of a communication system according to a first embodiment.

FIG. 2 is a block diagram illustrating a view of an image formation device and a mobile terminal according to a first embodiment.

FIG. 3 is a block diagram illustrating a view of an IC tag according to a first embodiment.

FIG. 4 is a flow chart illustrating a print instruction process of the mobile terminal according to a first embodiment.

FIG. 5 is a flow chart illustrating a printing process of the image formation device according to a first embodiment.

FIG. 6 is a block diagram illustrating a view of an image formation device and a mobile terminal according to a second embodiment.

FIG. 7 is a block diagram illustrating a view of an IC tag according to a second embodiment.

FIG. 8 is a flow chart illustrating a print instruction process of the mobile terminal according to a second embodiment.

FIG. 9 is a flow chart illustrating a printing process of the image formation device according to a second embodiment.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

With reference to the drawings, communication systems, image formation devices, and communication systems according to one or more embodiments are described below.

### First Embodiment

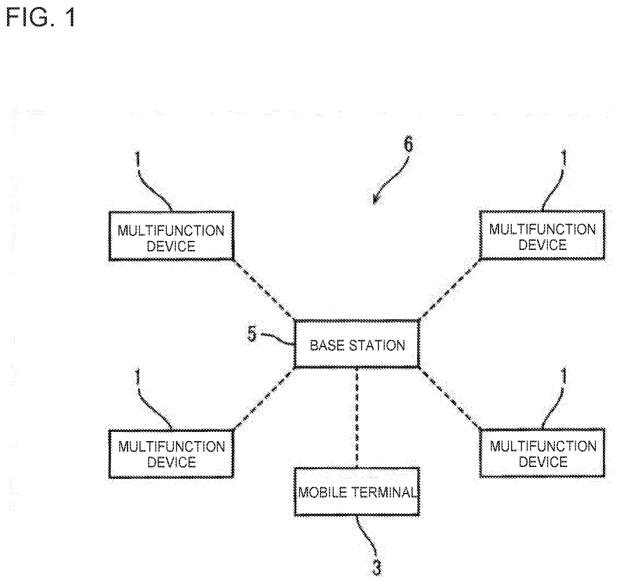

A communication system and an image formation device according to a first embodiment are described below with reference to FIG. 1 to FIG. 5. As illustrated in FIG. 1, the communication system according to a first embodiment includes a plurality of MFPs (Multi-Function Printers, hereinafter may be referred to as multifunction devices) 1, serving as image formation devices, which belong to the same group, such as the same company, the same department, the same section, and the same floor, the like, and a mobile terminal 3, wherein the mobile terminal 3 is connected to the multifunction devices 1 via a single local area network 6 (hereinafter referred to as network 6) having a base station 5 using a first wireless configuration.

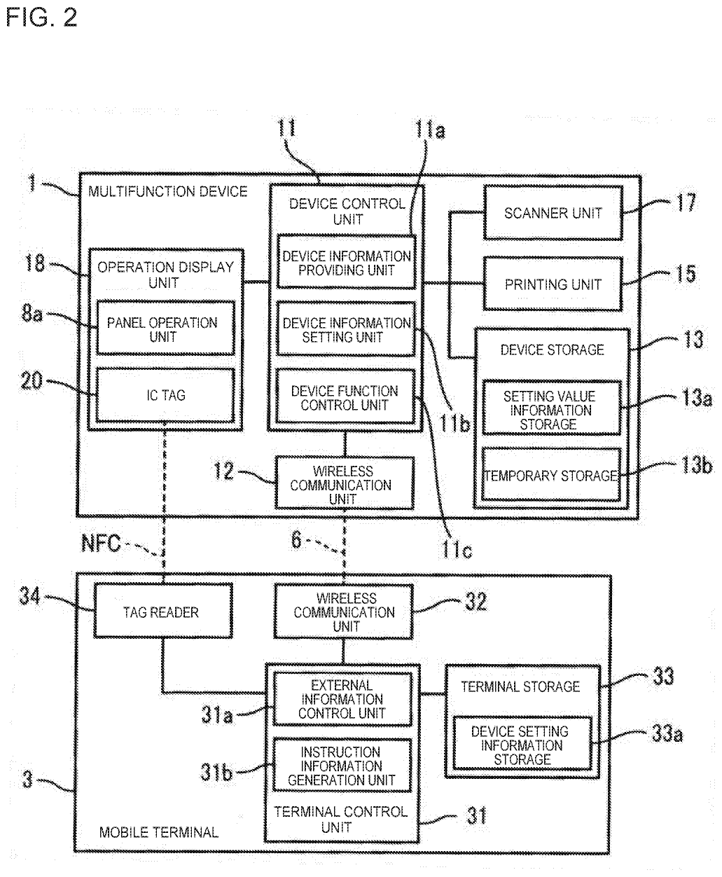

In a first embodiment, a wireless communication between each multifunction device 1 and the mobile terminal 3 via the network 6 is performed in an infrastructure mode. Each of the multifunction devices 1 is a device shared within the same group and has a communication function, a printing function, a scanning function, and the like, and may include the configuration illustrated in FIG. 2.

A device control unit 11 (or a device controller) of the multifunction device 1 has a function of controlling each unit or part in the multifunction device 1 and executing communication processing, printing processing, scanning processing, and the like. The wireless communication unit 12 as a device communication unit has a function of performing wireless data transmission/reception with the mobile terminal 3 via the network 6.

A device storage 13 stores therein programs to be executed by the device control unit 11, various data used for the programs, processing results by the device control unit 11, and the like. A printing unit 15 includes a paper cassette that accommodates therein printing paper, an image formation unit that forms a toner image to be printed on the paper, a transfer unit that transfers the toner image formed by the image formation unit to the paper, a fixing unit that fixes the transferred toner image onto the paper to form printed paper, and a discharge unit that discharges the printed paper from the fixing unit to the outside. The printing unit 15 receives print instruction and prints on paper an image and/or character strings based on print data in the received print instruction.

A scanner unit 17 includes a scanner having a line sensor such as a CCD (Charge Coupled Device) or the like, and has a function of reading character strings or an image on a document set on the multifunction device 1. An operation display unit 18 is provided on the front of the multifunction device 1 and includes a display screen such as an LCD, a position signal detecting unit such as a touch panel, and the like. The operation display unit 18 has a function to display a display screen on which the state of the device is to be displayed, a setting screen through which the user can input device information or the like, various input screens, and/or the like.

A panel operation unit 18a includes various operation keys including a numeric keypad having a toggle input function, a cross key, a “confirm” key, a “setting” key, and the like, a power switch to turn on the power to the multifunction device 1, and the like. The panel operation unit 18 has a function of accepting an input operation by the user. An input means or an input part according to an embodiment may include the position signal detecting unit provided on the operation display unit 18 and the various operation keys provided on the panel operation unit 18a.

An IC tag 20 is provided in the operation display unit 18 of the multifunction device 1 and stores therein connection information for connecting to the own multifunction device via the network 6. The IC tag 20 has a function (NFC function) for performing a near field communication (NFC) between the IC tag and the mobile terminal 3 as a second wireless configuration. The details of the NFC function will be described later.

The connection information according to an embodiment is network information for identifying the multifunction device 1 and includes, for example, an identification (ID) information of the base station 5, an identification (ID) information of the multifunction device 1 (referred to as a device ID), and the like. The device control unit 11 includes a device information providing unit 11a, a device information setting unit 11b, a device function control unit 11c, and the like.

The device information providing unit 11a has a function of reading the setting value information of the own multifunction device 1 from the device storage 13 in response to a request from the outside, and providing the read setting value information to the request source. The device information setting unit 11b has a function of individually changing each setting of setting value information stored in the device storage 13 based on information acquired from the operation display unit 18 and the wireless communication unit 12.

The device function control unit 11c includes a function to acquire and process image data in response to a print instruction or a scan instruction received from the mobile terminal 3 by the wireless communication unit 12, and cause the printing unit to executed printing of an image and/or character strings or cause the scanner unit 17 to execute scanning an image and/or character strings on a document. The device storage 13 is provided with a setting value information storage 13a, a temporary storage 13b, and etc. The setting value information storage 13a has the current setting value information of the multifunction device 1 stored. When a change in the setting value information is notified from the device control unit 11, the set values of the stored setting value information are individually rewritten to the notified setting values so as to be stored in the setting value information storage 13a. The setting value information of the multifunction device 1 according to a first embodiment includes setting information of the NFC function being set to be active or inactive, setting information of the device wireless function being set to be active or inactive, and so on.

When notified from the device control unit 11 to change the setting value information, the temporary storage 13b functions as a storage area to temporarily save the current setting value information that is currently stored in the setting value information storage 13a before the change. The mobile terminal 3 according to a first embodiment may be a portable information terminal such as a smartphone, a tablet terminal, or a laptop personal computer possessed by the user, and may include the configuration illustrated in FIG. 2.

A terminal control unit 31 (or a terminal controller) of the mobile terminal 3 has a function of controlling each unit or part in the mobile terminal 3 to perform communication processing via the network 6. A wireless communication unit 32 as a terminal communication unit has a function of performing wireless data transmission/reception with the wireless communication unit 12 of the multifunction device 1 via the network 6.

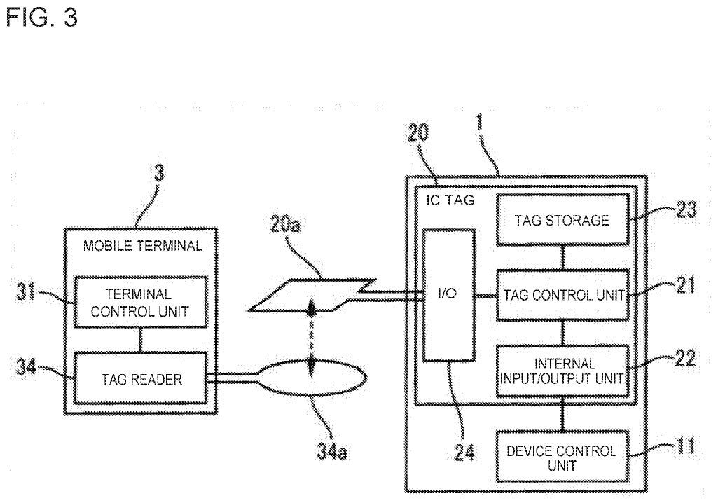

A terminal storage 33 stores programs to be executed by the terminal control unit 31, various data used for the programs, processing results by the terminal control unit 31, and the like. A tag reader 34 of the mobile terminal has a function, when the mobile terminal 3 is brought close to the IC tag 20 of the multifunction device 1, to read the connection information and the like stored in the IC tag 2 via the terminal antenna 34a (see FIG. 3) using the NFC function.

The terminal control unit 31 according to a first embodiment includes an external information control unit 31a, an instruction information generation unit 31b, and the like. The external information control unit 31a has a function to take information acquired by communicating with the outside such as the multifunction device 1 or the like using the wireless communication unit 32 or the tag reader 34 into the mobile terminal 3, and a function to transmit, through the wireless communication unit 32 to the outside, instruction information and the like for the multifunction device 1 generated by the instruction information generation unit 31b.

The instruction information generation unit 31b has a function to generate instruction information and the like for changing the setting value information of the multifunction device 1 based on the information acquired from the external information control unit 31a, and a function to generate a print instruction or a scan instruction to the multifunction device 1. The terminal storage 33 includes a device setting information storage 33a that stores therein information on the multifunction device 1 acquired by the external information control unit 31a.

Accordingly in a first embodiment, data is transmitted and received wirelessly via the network 6 between the wireless communication unit 12 of the multifunction device 1 and the wireless communication unit 32 of the mobile terminal 3, and data is read using the NFC function between the IC tag 20 of the multifunction device 1 and the tag reader 34 of the mobile terminal 3.

As illustrated in FIG. 3, the IC tag 20 according to a first embodiment includes a tag control unit 21, an internal input/output unit 22, a tag storage 23, an external input/output unit 24, and the like. The tag control unit 21 of the IC tag 20 has a function to control each unit or part in the IC tag 20 to execute the communication process through the NFC.

The internal input/output unit 22 has a function to connect the tag control unit 21 and the device control unit 11 for transmission and reception of data therebetween. The tag storage 23 includes a non-volatile memory and the like. The tag storage 23 stores therein programs to be executed by the tag control unit 21 and various data used therein. The tag storage 23 also stores therein the connection information of the multifunction device 1 output from the device control unit 11 via the internal input/output unit 22.

The external input/output unit 24 has a function to connect the tag control unit 21 and the tag antenna 20a for transmission and reception of data therebetween. When the tag antenna 20a receives an electromagnetic power supply from the terminal antenna 34a of the mobile terminal 3, the tag control unit 21 reads information including the connection information stored in the tag storage 23, and outputs the read information to the tag reader 34 of the mobile terminal 3 by the NFC function via the tag antenna 20a and the terminal antenna 34a, so that the terminal control unit 31 of the mobile terminal can obtain the connection information and the like received by the tag reader 34.

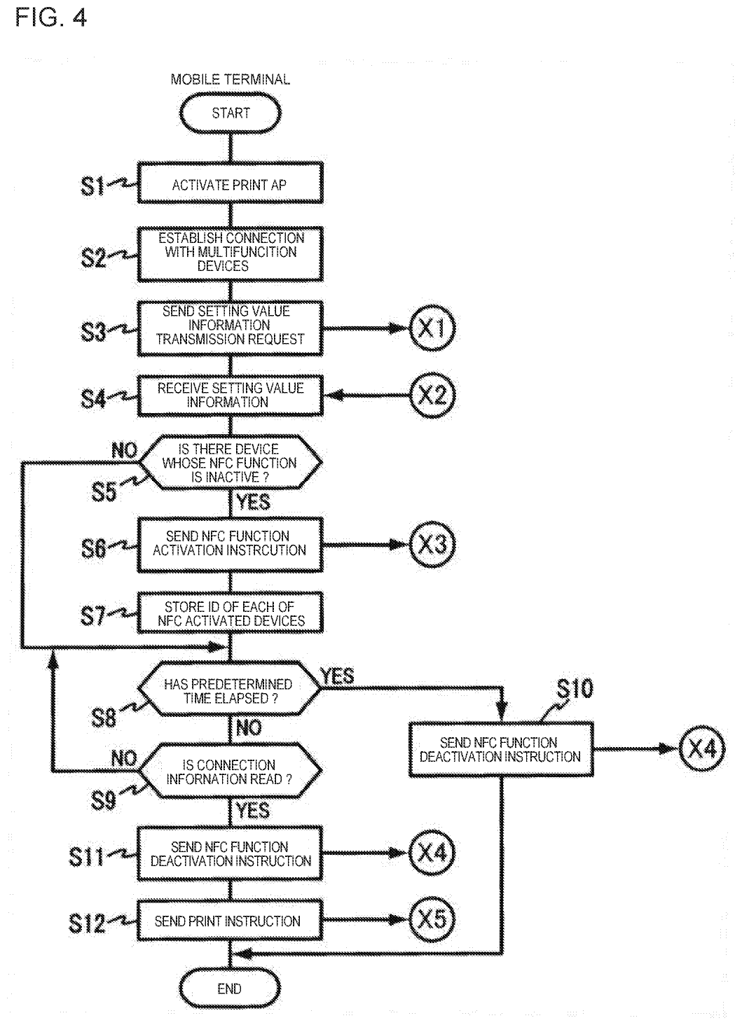

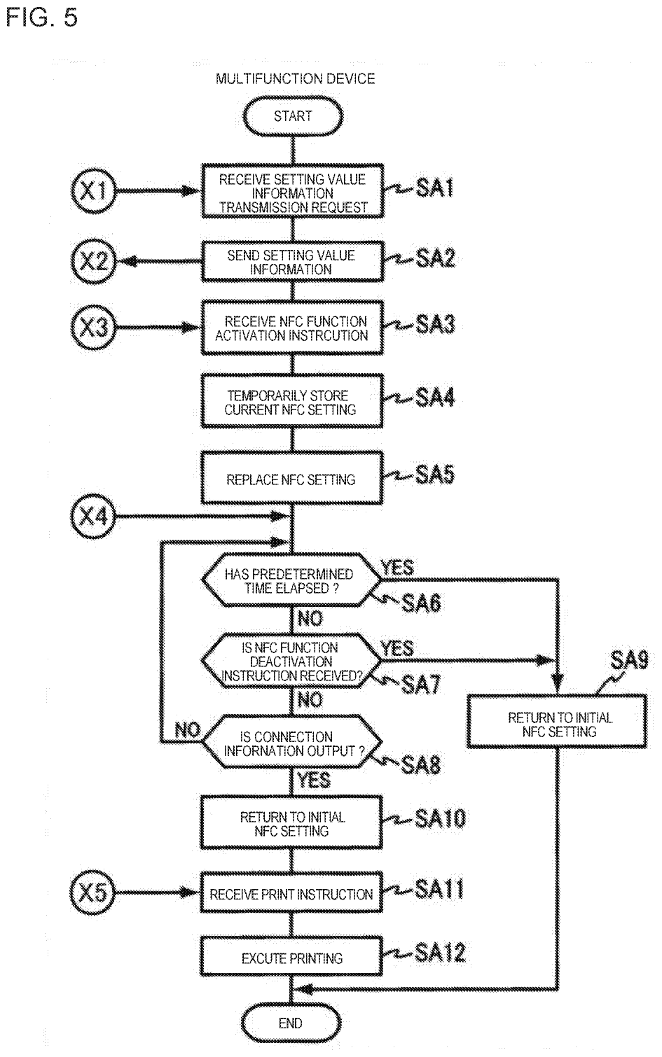

With reference to flow charts illustrated in FIGS. 4 and 5, an example of operations of a holding-mobile-over communication process of the communication system according to a first embodiment is described.

In this disclosure, the holding-mobile-over communication means the wireless communication between the multifunction device 1 and the mobile terminal 3 through the network 6 established based on the connection information, necessary for establishing the wireless communication through the network 6, that is acquired through the NFC connection by holding the mobile terminal 3 over the IC tag 20 of the multifunction device 1.

Note that operations of a print instruction process in the mobile terminal 3 is described according to the steps indicated by “S” in FIG. 4, and operations of a print process in the multifunction device 1 is described according to the steps indicated by “SA” in FIG. 5. The operations of the multifunction devices 1 that belong to the same network 6 are the same, and thus in the following example, the operations in only one multifunction device 1 is described for simplifying the description.

Step S1 (FIG. 4): The user who has the mobile terminal 3 activates the print AP installed in the mobile terminal 3 when trying to print an image and/or character strings stored in the mobile terminal 3. At this time, the NFC function of the mobile terminal 3 is disabled.

Step S2: The terminal control unit 31 that has recognized the activation of the print AP establishes an infrastructure mode connection with each multifunction device 1 through the wireless communication unit 32, in order to obtain the setting value information of each multifunction device 1 belonging to the same network 6.

Step S3: The terminal control unit 31 that has established the connection with each multifunction device 1 transmits a request for transmission of the setting value information from the wireless communication unit 32 via the network 6 to the wireless communication unit 12 of each multifunction device 1, and then proceeds to step S4. Note that this transmission request is transmitted to step SA1 in FIG. 5 as indicated by the connector X1.

Step SA1 (FIG. 5): When the operation of the multifunction device 1 is started, the device control unit 11 waits for receiving the transmission request for the setting value information from the mobile terminal 3 by the wireless communication unit 12. The device control unit 11 continues to wait for the setting value information transmission request until it is received, and proceeds to step SA2 when the transmission request is received.

Step SA2: The device control unit 11 of the multifunction device 1 that has received the setting value information transmission request reads the setting value information of its own multifunction device from the setting value information storage 13a of the device storage 13 by the device information providing unit 11a, processes the read setting value information into a configuration that can be processed by the mobile terminal 3, and transmits it from the wireless communication unit 12 to the wireless communication unit 32 of the requesting mobile terminal 3 via the network 6. This transmission is transmitted to step S4 in FIG. 4 as indicated by the connector X2.

Step S4: when the terminal control unit 31 of the mobile terminal that has been waiting for the setting value information from each multifunction device 1 after transmitting the setting value information transmission request, receives the setting value information from all the transmitted multifunction devices 1, the process proceeds to step S5. If the setting value information has not yet been received from any of the multifunction devices 1, the above-described standby is continued.

Step S5: The terminal control unit 31 that has received the setting value information from all the multifunction devices 1 analyzes the setting value information received by the external information control unit 31a in order to determine whether the multifunction device 1 having the NFC function is present in the vicinity. If the setting of the NFC function (referred to as NFC setting) of any one of the multifunction devices 1 is turned off, the process proceeds to step S6. If the NFC settings of all the multifunction devices 1 are turned on, the process proceeds to step S8.

Step S6: The terminal control unit 31 that has recognized that the NFC function of any one of the multifunction devices 1 is turned off causes the instruction information generation unit 31b to generate an NFC function activation instruction to turn on the NFC function of the multifunction device 1, transmits via the network 6 the generated NFC function activation instruction to the multifunction device 1 in which the NFC setting is turned off, and then proceeds to step S7. This transmission of the NFC function activation instruction is transmitted to step SA3 in FIG. 5 as indicated by the connector X3.

Step SA3: The device control unit 11 that has been waiting for reception of the NFC function activation instruction from the mobile terminal 3 after transmitting the setting value information proceeds to step SA4, when receiving the NFC function activation instruction. Note that the device control unit 11 continues to wait for the NFC function activation instruction until it is received.

Step SA4: The device control unit 11 that has received the NFC function activation instruction notifies the device information setting unit 11b that the NFC function thereof is to be turned on. The device information setting unit 11b then reads out the current setting value information stored in the setting value information storage 13a, and temporarily saves the read current setting value information into the temporary storage 13b.

Step SA5: The device information setting unit 11b that has temporarily stored the current setting value information rewrites the NFC setting of the setting value information to be active based on the notification from the device control unit 11, stores the rewritten new setting value information in the setting value information storage 13a, turns on the NFC function of the IC tag 20, and then proceeds to step SA6.

Step S7: On the other hand, the terminal control unit 31 of the mobile terminal that has transmitted the NFC function activation instruction in step S6 stores, to the device setting information storage 33a of the terminal storage 33, the information such as the device ID of each multifunction device 1 to which the NFC function activation instruction has been transmitted, and then proceeds to step S8.

Step S8: The terminal control unit 31 that has shifted from step S5 or step S7 activates (enables) the NFC function of the mobile terminal 3 to start the electromagnetic power supply from the tag reader 34, waits for a predetermined time (for example, 3 minutes), and then proceeds to step S10 when the predetermined time has elapsed. If the predetermined time has not elapsed, the process proceeds to step S9.

Step S9: The terminal control unit 31 that has started the electromagnetic power supply from the tag reader 34 waits for the user who has activated the printing AP to hold the mobile terminal 3 over the IC tag 20 of the multifunction device 1. When the mobile terminal 3 is held over the IC tag 20 of the multifunction device 1, the connection information is read from the IC tag 20 of the multifunction device 1 by means of the NFC function, and then the process proceeds to step S11.

If the connection information has not been read, the process returns to step S8 to continue the waiting in steps S8 and S9.

Step S10: The terminal control unit 31 that has recognized that the connection information could not be read within the predetermined time, turns off the NFC function of the mobile terminal 3 back, causes the instruction information generation unit 31b to generate an NFC function deactivation instruction to turn off the NFC function of the multifunction device 1, transmits via the network 6 the generated NFC function deactivation instruction to all the multifunction devices 1 whose device IDs are stored in the device setting information storage 33a. Then, the terminal control unit 31 terminates the print instruction process started with the activation of the current print AP. This transmission of the NFC function deactivation instruction is transmitted to step SA6 in FIG. 5 via connector X4.

Step S11: The terminal control unit 31 that has read the connection information from the IC tag 20 of the multifunction device 1 by the tag reader 34 returns the NFC function of the mobile terminal 3 back to be inactive(disable), saves the connection information read by the external information control unit 31a into the terminal storage 33, generates an NFC function deactivation instruction in the same way as in step S10, and transmits the generated NFC function deactivation instruction via the network 6 to the multifunction devices 1 whose device IDs are saved in the device setting information storage 33a except for the multifunction device 1 from which the connection information is read. Then, the process proceeds to step S12. This transmission of the NFC function deactivation instruction is transmitted to step SA6 in FIG. 5 via connector X4.

If the NFC setting of the setting value information received in step S4, of the multifunction device 1 from which the connection information has read, indicates the NFC function has been already turned on, the terminal control unit 31 sends the NFC function deactivation instruction to all the multifunction devices 1 whose device IDs are stored in the device setting information storage 33a.

Step SA6: The device control unit 11 waits for a predetermined time (for example, 3 minutes) from when the NFC function of the IC tag 20 is turned on in step SA5, and proceeds to the step SA9 when the predetermined time has elapsed. If the predetermined time has not elapsed, the process proceeds to step SA7.

Step SA7: The device control unit 11 waits for reception of the NFC function deactivation instruction from the mobile terminal 3, and proceeds to step SA9 when receiving the NFC function deactivation instruction from the mobile terminal 3. If no NFC function deactivation instruction has received, the process proceeds to step SA8.

Step SA8: The device control unit 11 waits for the user to hold the mobile terminal 3 over the IC tag 20. When the mobile terminal 3 is held over the IC tag 20 so that the IC tag 20 receives the electromagnetic power from the mobile terminal 3, the device control unit 11 causes the tag control unit 21 to output the connection information stored in the tag storage 23 to the tag reader 34 of the mobile terminal 3 via the tag antenna 20a, and then proceeds to step SA10.

If the connection information has not been output, the process returns to step SA6, and continues the standby in steps SA6 to SA8.

Step SA9: The device control unit 11 that has determined that the predetermined time has elapsed in step SA6, or that has received the NFC function deactivation instruction in step SA7, reads out the initial (previous) setting value information temporarily stored in the temporary storage 13b of the device storage 13, that is, the setting value information in which the NFC function is deactivated, stores the read information into the setting value information storage 13a, returns the NFC function of the setting value information of the multifunction devices 1 back to the initial state (previous state), and then terminates the printing process started with the reception of the setting value information transmission request.

Step SA10: The device control unit 11 that has recognized the output of the connection information returns the setting value information to the initial state in the same manner as step SA9 and then proceeds to step SA11.

Step S12: On the other hand, the terminal control unit 31 that has transmitted the NFC function deactivation instruction in step S11 establishes the connection between the wireless communication unit 32 of the mobile terminal 3 and the wireless communication unit 12 of the multifunction device 1 via the network 6, based on the connection information read by the tag reader 34 and stored in the terminal storage 33. The terminal control unit 31 further causes the instruction information generation unit 31b to generate a print instruction with print data including an image and/or character strings selected by the user, and transmits the generated print instruction via the network 6, to the multifunction device 1 whose connection information has been read through the NFC function. This transmission of the print instruction is transmitted to step SA11 in FIG. 5 via the connector X5.

Then, the terminal control unit 31 ends the print instruction process started with the activation of the current print AP.

Step SA11: The device control unit 11 that has returned the setting value information to the original state after outputting the connection information, waits for reception of the print instruction from the mobile terminal 3, and when receiving the print instruction, proceeds to step SA12. The device control unit 11 continues to wait for the print instruction until receiving the print instruction.

Step SA12: The device control unit 11 that has received the print instruction causes the device function control unit 11c to print the image and/or character strings of the print data attached to the received print instruction on the paper by the printing unit 15 and to discharge the printer paper to the outside of the printing unit 15, and then terminates the printing process started with the reception of the current setting value information transmission request.

On the other hand, the user who visually recognizes the discharged printed paper receives the printed paper on the multifunction device 1. In this way, the holding-mobile-over communication process by the communication system according to a first embodiment is executed.

As described above, according to a first embodiment, in a case where the user who possesses the mobile terminal 3 wants to use the NFC function to executes printing or the like by the multifunction device 1, the NFC function of all of the multifunction devices 1 belonging to the same network 6 can be turned on in advance in response to the activation of the print AP on the mobile terminal 3 even if there were one or more multifunction devices whose the NFC functions have been turned off.

Accordingly, the user does not need to manually turn on the NFC function of the multifunction device 1, and thus unnecessary operations by the user can be suppressed, and the user terminal can read the connection information using the NFC function without the user being aware of the NFC setting of the multifunction device 1. This can improve the convenience of the user in the use of the multifunction device 1 having the NFC function

Further according to a first embodiment, even when the NFC functions of the multifunction devices 1 that are set in power saving modes are changed to be active (enable), the multifunction devices 1 whose NFC functions are not used after the activation are returned to their initial inactive (disabled) states. This can suppress the power consumptions of the multifunction devices that are set in the power saving modes.

Further according to a first embodiment, even when the NFC settings of the multifunction devices 1 that are set in the power saving modes are changed to be active (enable), the NFC function deactivation instruction is transmitted immediately after reading out the connection information through the NFC function by the mobile terminal 3, to return the NFC setting of the multifunction device 1 to the initial deactivation state. This can shorten the waiting time of the multifunction device 1 that continues to wait after activating the NFC function of the multifunction device 1. Accordingly, this can further suppress the power consumptions of the multifunction devices 1 that are set in the power saving modes.

This is because, in the power saving mode of the multifunction device 1 to save the power consumed in the multifunction device, the NFC function of the multifunction device 1 may be turned off (deactivated). Note that when the NFC function of the multifunction device 1 is activated, the device control unit 11 provides the power supply to the IC tag 20 to write information in the IC tag 20 upon transitions or the like in the multifunction device 1.

### Second Embodiment

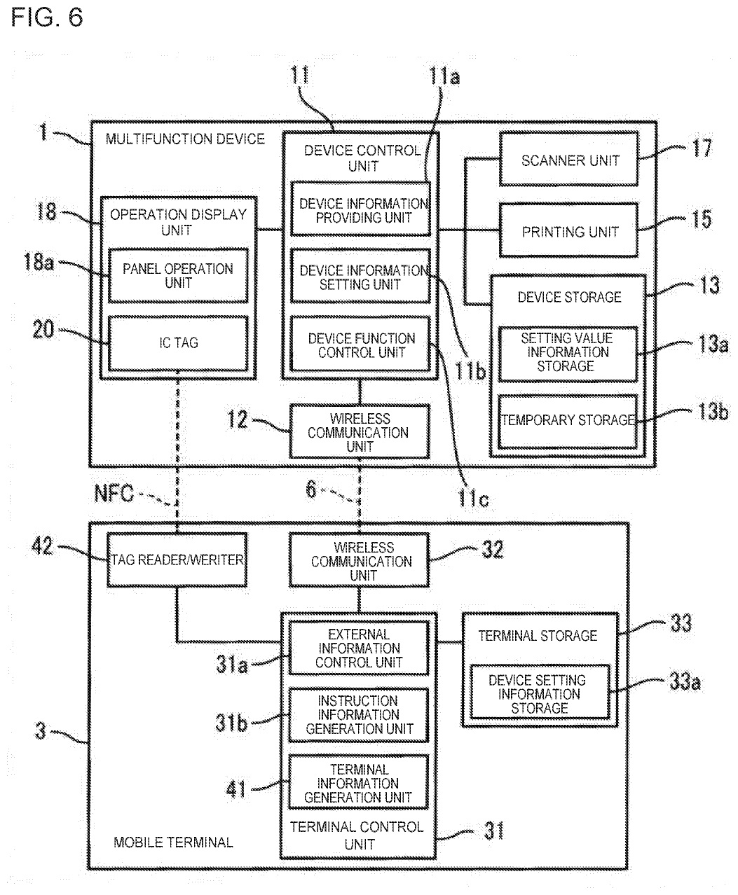

With reference to FIG. 6 to FIG. 9, a communication system and an image formation device according to a second embodiment are be described. The same parts as those of the above-mentioned first embodiment are denoted by the same reference numerals and the descriptions thereof are omitted to eliminate redundancy.

The setting value information storage 13a of the device storage 13 of the multifunction device 1 according to a second embodiment stores the setting value information in a manner same as or similar to the above-described first embodiment, but the stored setting value information of the multifunction device 1 includes setting of the NFC function being set to active, inactive, or restricted active, and setting of the wireless function being set to active or inactive.

The restricted active means that only the mobile terminal 3 that has sent terminal identification information thereof (described later) is allowed to use the NFC function in order to limit the users who use the NFC function of the multifunction device 1.

The temporary storage 13b of the device storage 13 of the multifunction device 1 temporarily stores the current setting value information stored in the setting value information storage 13a in a manner same as or similar to the above-described first embodiment, and further temporally stores the terminal identification information of the mobile terminal 3 transmitted via the network 6 from the mobile terminal 3.

The device function control unit 11c of the device control unit 11 of the multifunction device 1 has the function to execute printing and scanning in response to the print instruction and the scan instruction received from the mobile terminal 3 in a manner same as or similar to the above-described first embodiment, and further has a function to determine whether the terminal identification information written to the IC tag 20 matches the terminal identification information received via the network 6 and temporarily stored in the temporary storage 13b, to restrict users who are not allowed to use the NFC function of the multifunction device 1.

The terminal control unit 31 of the mobile terminal 3 according to a second embodiment further includes a terminal identification information generation unit 41. The terminal identification information generation unit 41 has a function to generate the terminal identification information that is used for the multifunction device 1 that receives the print instruction to identify the mobile terminal 3 from which the print instruction is transmitted. The terminal identification information according to a second embodiment may be a serial number of the mobile terminal 3, that is, a product serial number of the mobile terminal 3.

The instruction information generation unit 31b of the terminal control unit 31 of the mobile terminal 3 has the function to generate instruction information for changing the setting value information of the multifunction device 1, and the function to generate the print instruction and the scan instruction in 3 in a manner same as or similar to the above-described first embodiment. The instruction information generation unit 31b further has a function to attach the terminal identification information generated by the terminal identification information generation unit 41 to the generated instruction information.

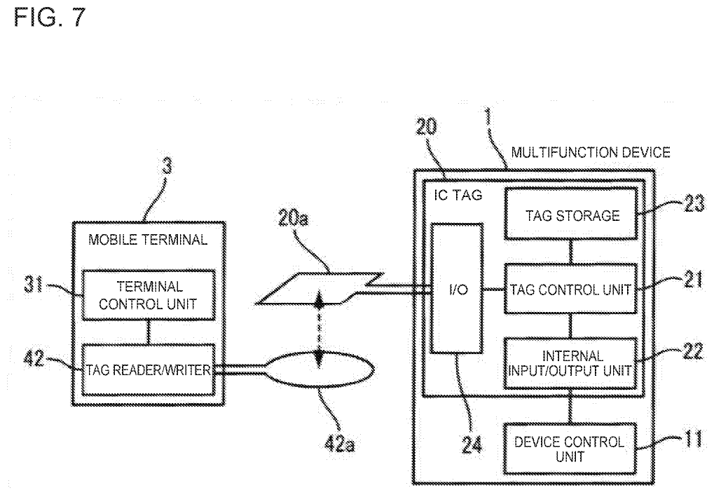

As illustrated in FIG. 7, the mobile terminal 3 according to a second embodiment includes a tag reader/writer 42 instead of the tag reader 34 according to the above-described first embodiment. The mobile terminal 3 has the function to read the connection information and the like written in the IC tag 20 of the multifunction device 1 by bringing the terminal antenna 42a of the mobile terminal 3 close to the IC tag 20 and further has a function to write, into the IC tag 20 of the multifunction device 1 via the terminal antenna 42a and the tag antenna 20a, the terminal identification information generated by the terminal identification information generation unit 41 of the mobile terminal 3.

As described above, according to a second embodiment, the wireless data communication (transmission/reception) via the network 6 is performed between the wireless communication unit 12 of the multifunction device 1 and the wireless communication unit 32 of the mobile terminal 3, and the data transmission (read/write) through the NFC function is performed between the IC tag 20 of the multifunction device 1 and the tag reader/writer 42 of the mobile terminal 3.

According to a second embodiment, when receiving the electromagnetic power from the terminal antenna 42a of the mobile terminal 3, the tag control unit 21 reads the connection information and the like stored in the tag storage 23, outputs the read connection information and the like to the tag reader/writer 42 of the mobile terminal 3 through the tag antenna 20a and the terminal antenna 42a by using NFC function. The tag reader/writer 42 receives and the terminal control unit 31 obtains the output connection information and the like. When the terminal identification information of the mobile terminal 3 is output from the tag reader/writer 42 to the IC tag 20 of the multifunction device 1, the tag control unit 21 of the IC tag 20 writes and stores the received terminal identification information in the tag storage 23.

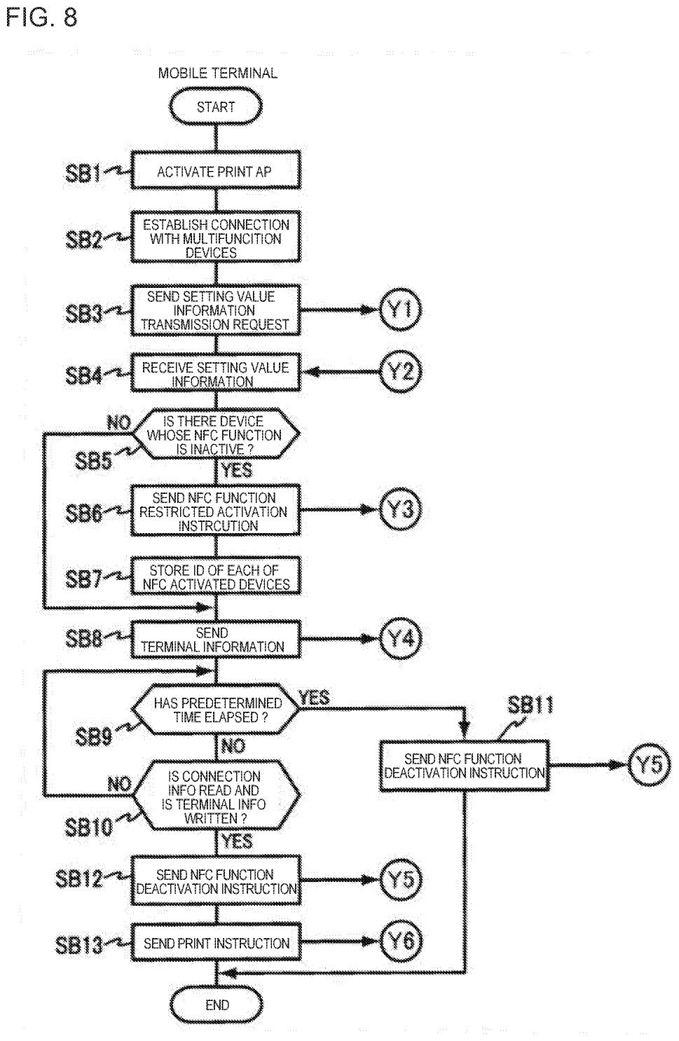

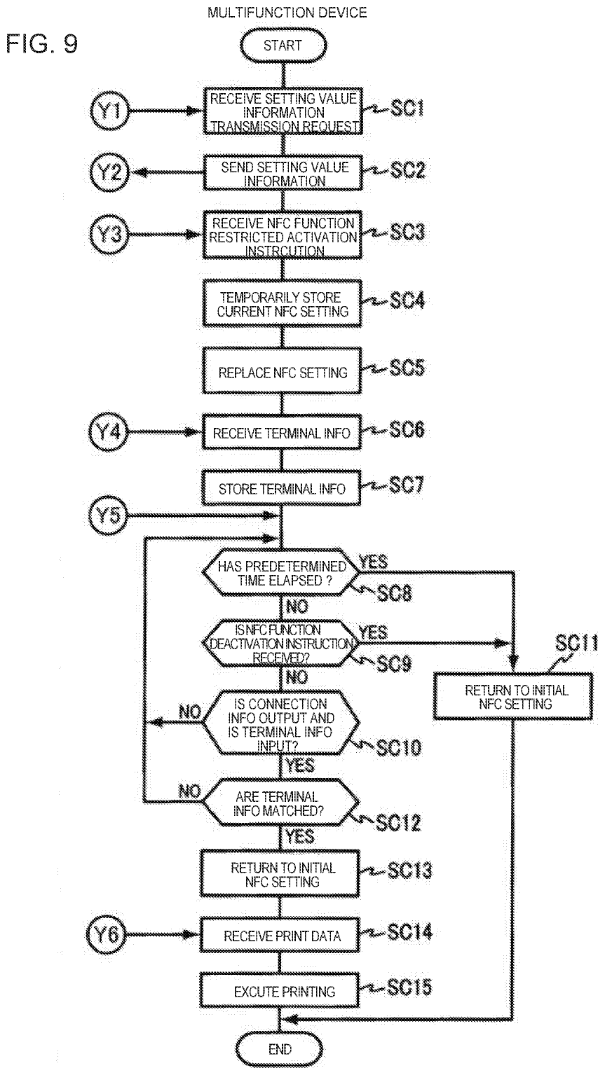

With reference to flow charts illustrated in FIGS. 8 and 9, an example of operations of a holding-mobile-over communication process of the communication system according to a second embodiment is described. Note that operations of a print instruction process in the mobile terminal 3 is described according to the steps indicated by “SB” in FIG. 8, and operations of a print process in the multifunction device 1 is described according to the steps indicated by “SC” in FIG. 9.

Not that the operations of the multifunction devices 1 that belong to the same network 6 are the same, and thus in the following example, the operations in only one multifunction device 1 is described for simplifying the description. In a second embodiment, the steps SB1 to SB5 (FIG. 8) of the mobile terminal 3 and the steps SC1 to SC2 (FIG. 9) of the multifunction device 1 are the same as steps S1 to S5 (FIG. 3) of the mobile terminal 3 and the steps SA1 to SA2 (FIG. 5) of the multifunction device 1, respectively, and thus the descriptions thereof are omitted to eliminate redundancy.

In step SB5, if the NFC functions of all the multifunction devices 1 are active or restricted active, the process proceeds to step SB8.

Step SB6 (FIG. 8): The terminal control unit 31 that has recognized in the step SB5 that the NFC function of any one of the multifunction devices 1 is turned off causes the instruction information generation unit 31b to generate an NFC setting restricted activation instruction to restrictively activate the NFC function of the multifunction device 1, transmits via the network 6 the generated NFC setting restricted activation instruction to the multifunction device 1 in which the NFC function is turned off, and then proceeds to step SB7.

This transmission of the NFC setting restricted activation instruction is transmitted to step SC3 in FIG. 9 as indicated by the connector Y3.

Step SA3: The device control unit 11 that has been waiting for reception of the NFC setting restricted activation instruction from the mobile terminal 3 after transmitting the setting value information proceeds to step SC4, when receiving the NFC setting restricted activation instruction. Note that the device control unit 11 continues to wait for the NFC setting restricted activation instruction until it is received.

Step SC4: The device control unit 11 that has received the NFC setting restricted activation instruction notifies the device information setting unit 11b that the NFC function will be turned on. The device information setting unit 11b reads out the current setting value information stored in the setting value information storage 13a, and temporarily saves the read current setting value information into the temporary storage 13b.

Step SC5: The device information setting unit 11b that has temporarily stored the current setting value information rewrites the NFC setting of the setting value information to be active based on the notification from the device control unit 11, stores the rewritten new setting value information in the setting value information storage 13a, and then proceeds to step SC6.

Step SB7: On the other hand, the terminal control unit 31 that has transmitted the NFC setting restricted activation instruction in step SB6 stores, to the device setting information storage 33a of the terminal storage 33, the information such as the device ID of each multifunction device 1 to which the NFC setting restricted activation instruction has been transmitted.

Step SB8: The terminal control unit 31 that has shifted from step SB5 or step SB7 transmits the terminal identification information generated by the terminal identification information generation unit 41, via the network, to the multifunction devices 1 whose NFC functions are indicated as restricted active states by the setting value information received in step SB4 as well as the multifunction devices 1 to which the NFC setting restricted activation instruction has been transmitted. Then the terminal control unit 31 proceeds to step SB9. This transmission of the terminal identification information is transmitted to step SC6 in FIG. 9 as indicated by the connector Y4.

Step SC6: The device control unit 11 that has been waiting for the terminal identification information from the mobile terminal 3 proceeds to step SC7, when receiving the terminal identification information. The device control unit 11 continues to wait for the terminal identification information until it is received.

Step SC7: The device control unit 11 that has received the terminal identification information from the mobile terminal 3 stores the received terminal identification information into the temporary storage 13b of the device storage 13 and activates the NFC function of the IC tag 20, and then proceeds to step SC8.

Step SB9: On the other hand, the terminal control unit 31 that has transmitted the terminal identification information in step SB8 activates (enables) the NFC function of the mobile terminal 3 to start the electromagnetic power supply from the tag reader/writer 42, waits for a predetermined time (for example, 3 minutes), and then proceeds to step SB11 when the predetermined time has elapsed. If the predetermined time has not elapsed, the process proceeds to step SB10.

Step SB10: The terminal control unit 31 that has started the electromagnetic power supply from the tag reader/writer 42 waits for the user who has activated the printing AP to hold the mobile terminal 3 over the IC tag 20 of the multifunction device 1. When the mobile terminal 3 is held over the IC tag 20 of the multifunction device 1, the terminal control unit 31 reads the connection information from the IC tag 20 of the multifunction device 1 by and writes the terminal identification information to the IC tag 20 of the multifunction device 1 by using the NFC function, and then proceeds to step SB12. If the connection information has not been read and the terminal identification information has not been written, the process returns to step SB9 to continue the waiting in steps SB9 and SB10.

Step SB11: The terminal control unit 31 that has recognized that the connection information could not be read and the terminal identification information could not be written within the predetermined time, turns off the NFC function of the mobile terminal 3 back, and transmits via the network 6 the generated NFC function deactivation instruction to all the multifunction devices 1 whose device IDs are stored in the device setting information storage 33a in the same manner as in step S10 in the above described first embodiment. Then, the terminal control unit 31 terminates the print instruction process started with the activation of the current print AP. This transmission of the NFC function deactivation instruction is transmitted to step SC8 in FIG. 9 via connector Y5.

Step SB12: The terminal control unit 31 that has read the connection information from the IC tag 20 of the multifunction device 1 and has written the terminal identification information to the IC tag 20 by the tag reader/writer 42 returns the NFC function of the mobile terminal 3 back to be inactive (disable), saves the connection information read by the external information control unit 31a into the terminal storage 33, generates an NFC function deactivation instruction in the same way as in step SB11, and transmits the generated NFC function deactivation instruction via the network 6 to the multifunction devices 1 whose device IDs are saved in the device setting information storage 33a except for the multifunction device 1 from which the connection information is read. This transmission of the NFC function deactivation instruction is transmitted to step SC8 in FIG. 9 via connector Y5.

If the NFC setting of the setting value information received in step SB4, of the multifunction device 1 from which the connection information has read, indicates the NFC function has been already restrictively activated, the terminal control unit 31 sends the NFC function deactivation instruction to all the multifunction devices 1 whose device IDs are stored in the device setting information storage 33a.

Step SC8: The device control unit 11 waits for a predetermined time (for example, 3 minutes) from when the NFC function of the IC tag 20 is activated, and proceeds to the step SC11 when the predetermined time has elapsed. If the predetermined time has not elapsed, the process proceeds to step SC9.

Step SC9: The device control unit 11 waits for reception of the NFC function deactivation instruction from the mobile terminal 3, and proceeds to step SC11 when receiving the NFC function deactivation instruction from the mobile terminal 3. If no NFC function deactivation instruction has received, the process proceeds to step SC10.

Step SA8: The device control unit 11 waits for the user to hold the mobile terminal 3 over the IC tag 20. When the mobile terminal 3 is held over the IC tag 20 so that the IC tag 20 receives the electromagnetic power from the mobile terminal 3, the device control unit 11 causes the tag control unit 21 to output the connection information stored in the tag storage 23 to the tag reader/writer 42 of the mobile terminal 3 via the tag antenna 20a, stores the terminal identification information that is input from the tag reader/writer 42 into the tag storage 23, and then proceeds to step SC12. If the connection information and the like has not been output, the process proceeds back to step SC8, and continues the standby in steps SC8 to SC10.

Step SC11: The device control unit 11 that has determined that the predetermined time has elapsed in step SC8 or that has received the NFC function deactivation instruction in step SC9, reads out the initial setting value information temporarily stored in the temporary storage 13b of the device storage 13, that is, the setting value information in which the NFC function is deactivated, stores them into the setting value information storage 13a, returns the NFC function of the setting value information of the multifunction devices 1 to the initial state, and then terminates the printing process started with the reception of the setting value information transmission request.

Step SC12: The device control unit 11 that has stored the terminal identification information in the tag storage 23 in step SC 10, causes the device function control unit 11c to compare the terminal identification information stored in the tag storage 23 with the terminal identification information temporarily stored in the temporary storage 13b in step SC7. When two of the terminal identification information are matched, the device control unit 11 authenticates the user of the mobile terminal 3 to allow the wireless communication through the network 6, and then proceeds to step SC13.

When two of the terminal identification information are not matched, the device control unit 11 keeps the NFC function turned off and proceeds back to step SC8 to continue the standby in steps SC8 and SC9 and to continue to wait for input of a new terminal identification information in step SC10.

Step SC13: The device control unit 11 that has authenticated the user of the mobile terminal 3 to allow the wireless communication through the network 6 returns the setting value information of the multifunction device 1 to the initial state 3 in a manner same as or similar to step SC11 and proceeds to step SC14.

Step SB13: On the other hand, the terminal control unit 31 that has transmitted the NFC function deactivation instruction in step SB12 establishes the connection between the terminal wireless communication unit 32 and the wireless communication unit 12 of the multifunction device 1 via the network 6, based on the connection information read by the tag reader 34 and stored in the terminal storage 33. The terminal control unit 31 further causes the instruction information generation unit 31b to generate a print instruction with print data including an image and/or character strings selected by the user, and transmits the print instruction via the network 6, to the multifunction device 1 whose connection information has been read through the NFC function. This transmission of the print instruction is transmitted to step SC14 in FIG. 9 via the connector Y6. Then, the terminal control unit 31 ends the print instruction process started with the activation of the current print AP.

Step SC14: The device control unit 11 that has returned the setting value information to the initial state after outputting the connection information, waits for reception of a print instruction from the mobile terminal 3, and when receiving the print instruction, proceeds to step SC15. The device control unit 11 continues to wait for the print instruction until receiving the print instruction.

Step SC15: The device control unit 11 that has received the print instruction causes the device function control unit 11c to print the image and/or character strings of the print data attached to the received print instruction on the paper by the printing unit 15 and to discharge the printer paper to the outside of the printing unit 15, and then terminates the printing process started with the reception of the current setting value information transmission request.

On the other hand, the user who visually recognizes the discharged printed paper receives the printed paper on the multifunction device 1. In this way, the holding-mobile-over communication process by the communication system according to a second embodiment is executed.

In a second embodiment described above, each time the NFC function is used, the terminal identification information is transmitted from the mobile terminal 3 to the multifunction device 1 via the network 6 in the above step SB8. However, the invention is not limited to this. For example. if the multifunction device 1 can continue to store the terminal identification information, the transmission of the terminal identification information in step SB8 for the second or later use of the NFC function may be omitted. In this case, the user (or the mobile terminal 3) may be authenticated by comparing the terminal identification information stored in the multifunction device with the terminal identification information written in the IC tag 20.

In one or more embodiments described above, the terminal identification information of the mobile terminal 3 is the serial number of the mobile terminal 3. However, the invention is not limited to this. For example, the terminal identification information may be a user's password, a user's name, or the like. Also, any information that can specify the mobile terminal 3 for connection may be used as the terminal identification information.

According to a second embodiment described above, in addition to the same effect as in the first embodiment, the following effects can be obtained. Upon performing printing or the like by the multifunction device 1 using the NFC function, the terminal identification information of the mobile terminal 3 is previously transmitted to each multifunction device 1 on the same network 6 via the network 6, the same terminal identification information is next written to the IC tag 20 of the multifunction device 1 when using the NFC function, and then the NFC function can be used only when the terminal identification information written in the IC tag 20 via the NFC function matches the terminal identification information stored in the multifunction device 1 via the network. Accordingly, the user can be identified by the multifunction device 1. This makes it possible to prevent an unintended use of the NFC function of the multifunction device 1 and provide the NFC function with strong security.

In one or more embodiments described above, the wireless communication within the same group is performed using the infrastructure mode. However, the invention is not limited to this. For example, the wireless communication within the same group may be performed using an access point mode, a Wi-Fi direct, or the like.

In one or more embodiments described above, all of the multifunction devices 1 connected to the same network 6 have an NFC function. How, the invention is not limited to this. For example, in an embodiment, a multifunction device with no NFC function may be included. In a case where a multifunction device with no NFC function is included, an NFC function activation instruction or an NFC setting restricted activation instruction may not be transmitted to the multifunction device with no NFC function, and in a case where all multifunction devices have no NFC function, the holding-mobile-over communication process may be terminated.

In one or more embodiments described above, the printing process using the NFC function has been described as an example. However, the same effect as described above can be obtained in the scanning process or the like.

In this case, the user may set the document to be scanned in the scanner unit 17 of the multifunction device 1 to start the scan AP in step S1 or SB1, and may transmit an scan instruction via the network 6 from the mobile terminal 3 to start the scan function of the multifunction device 1 in step S12 or SB13. In step SA12 or SC15, the multifunction device 1 may read an image of the document set based on the scan instruction, and may transmit the read image to the mobile terminal 3 via the network 6. The mobile terminal 3 may store the received image in the terminal storage 33.

In one or more embodiments described above, the IC tag 20 of the multifunction device 1 is provided on the operation display unit 18. However, the invention is not limited to this. For example, the IC tag 20 may be provided in any visible part of the body of the multifunction device 1.

In one or more embodiments described above, the predetermined time to wait in the mobile terminal 3 and the predetermined time to wait in the multifunction device 1 are both 3 minutes. However, these predetermined times may be longer or shorter than 3 minutes, and may be different from each other. In short, the predetermined time may be set enough for the user's movement and/or the holding operation such that the connection information can be read by the NFC function and the terminal identification information can be reliably written.

In one or more embodiments described above, the multifunction device 1 is described as an example of an image formation device. However, an image formation device is not limited to this. For example, in an embodiment, an image formation device may be a multifunction device, printer, facsimile, and the like with an NFC function.

Note that each of the control units 11, 21, 31, and the like can be implemented using: a memory as a storage device that stores a control program; and a processor that executes the control program stored in the memory. Otherwise, parts of the control units 11, 21, 31, and the like may be implemented using a circuit, and the rests of the control units 11, 21, 31, and the like may be implemented using: a memory as a storage device that stores a control program; and a processor that executes the control program stored in the memory.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A communication system comprising:
a mobile terminal and an image formation device, wherein the mobile terminal and the image formation device are communicable via a network using a wireless connection and a tag reader of the mobile terminal and an IC tag of the image formation device are communicable by using an NFC function, in which the image formation device includes a storage storing therein a setting value information including an NFC setting and the IC tag storing therein a device identification information to identify the image formation device via the network, wherein
the mobile terminal comprises a controller configured with programs to perform operations comprising:
transmitting, via the network to the image formation device, a transmission request of the setting value information including the NFC setting of the image formation device;
when the NFC setting in the setting value information received via the network indicates the NFC function of the image formation device is inactive, transmitting, via the network to the image formation device, an activation instruction to activate the NFC function; and
after transmitting the activation instruction, reading, from the IC tag of the image formation device, the device identification information by means of the tag reader using the NFC function;
the image formation device includes a controller configured with programs to perform operations comprising:
when receiving, from the mobile terminal via the network, the transmission request of the setting value information of the image formation device, reading the setting value information from the storage of the image formation device and transmitting the setting value information to the mobile terminal; and
when receiving the activation instruction via the network from the mobile terminal, activating the NFC function of the image formation device.

2. The communication system according to claim 1, wherein
the controller of the mobile terminal performs operations further comprising:
transmitting a deactivation instruction to deactivate the NFC function of the image formation device via the network, to the image formation device to which the activation instruction has transmitted and that has not read the device identification information by means of the tag reader,
the controller of the image formation device performs operations further comprising:
deactivating the NFC function of the image formation device, when receiving the deactivation instruction via the network.

3. The communication system according to claim 1, wherein
the image formation device comprises image formation devices, and
the tag reader of the mobile terminal is a tag reader/writer, wherein
the mobile terminal comprises the controller configured with programs to perform operations comprising:
transmitting, via the network to each of the image formation devices, the transmission request of the setting value information including the NFC setting of the image formation device;
when the NFC setting in the setting value information received via the network indicates there is one or more image formation devices whose NFC functions are inactive, transmitting, via the network to the one or more image formation devices, a restricted activation instruction to activate the NFC function with restriction;
after transmitting the restricted activation instruction, transmitting terminal identification information to identify the mobile terminal via the network to the image formation devices whose NFC functions have already been active with the restriction and the one or more image formation devices to which the restricted activation instruction has been transmitted; and
after transmitting the terminal identification information, reading, from the IC tag of one of the image formation devices, the device identification information to identify the one of the image formation devices via the network by means of the tag reader/writer using the NFC function, and writing the terminal identification information of the mobile terminal to the IC tag of the one of the image formation devices,
each of the image formation devices includes the controller configured with programs to perform operations comprising:
when receiving, from the mobile terminal via the network, the transmission request of the setting value information of the image formation device, reading the setting value information from the storage of the image formation device and transmitting the setting value information to the mobile terminal;
when receiving the restricted activation instruction via the network from the mobile terminal, activating the NFC function of the image formation device with the restriction;
when receiving the terminal identification information via the network from the mobile terminal, storing the received terminal identification information in the storage of the image formation device; and
when the terminal identification information written in the IC tag matches the terminal identification information stored in the storage, allowing communication via the network.

4. An image formation device communicable with a mobile terminal via a network using a wireless connection, comprising:
an IC tag communicable with a tag reader of the mobile terminal through an NFC connection between the IC tag and the tag reader, wherein the IC tag stores therein a device identification information to identify the image formation device via the network;
a storage storing therein a setting value information including an NFC setting of the image formation device; and
a controller configured with programs to perform operations comprising:
when receiving, from the mobile terminal via the network, a transmission request of the setting value information of the image formation device, reading the setting value information from the storage of the image formation device and transmitting the setting value information to the mobile terminal; and
when receiving via the network from the mobile terminal an activation instruction to activate an NFC function of the image formation device, activating the NFC function of the image formation device.

5. The image formation device communicable according to claim 4, wherein
the controller of the image formation device performs operations further comprising:
deactivating the NFC function of the image formation device, when the device identification information of the image formation device is read by the tag reader of the mobile terminal through the NFC function.

6. The image formation device according to claim 4, wherein
the tag reader of the mobile terminal is a tag reader/writer, and
the controller configured with programs to perform operations comprising:
when receiving, from the mobile terminal via the network, the transmission request of the setting value information of the image formation device, reading the setting value information from the storage of the image formation device and transmitting the setting value information to the mobile terminal;
when receiving via the network from the mobile terminal a restricted activation instruction to activate the NFC function of the image formation device with restriction, activating the NFC function of the image formation device with the restriction;
when receiving via the network from the mobile terminal a terminal identification information to identify the mobile terminal, storing the received terminal identification information into the storage of the image formation device; and
allowing communication via the network, when terminal identification information written in the IC tag of the image formation device matches the received terminal identification information stored in the storage of the image formation device.

7. A communication method of communicating a mobile terminal with an image formation device via a network using a first wireless connection and via a near field communication (NFC) using a second wireless connection, comprising:
transmitting, via the network from the mobile terminal to the image formation device, an instruction to activate an NFC function of the image formation device from an inactive state;
communicating via the NFC between the mobile terminal and the image formation device, to receive a device identification information of the image formation device by the mobile terminal;
communicating, via the network between the mobile terminal and the image formation device that is identified by the device identification information; and
transmitting, via the network from the mobile terminal to the image formation device, an instruction to deactivate the NFC function of the image formation device from the activated state.
